(19) United States
(12) Patent Application Publication
(10) Pub. No.: US 2018/0244149 A1
(43) Pub. Date: Aug. 30, 2018

(54) FILLER NECK WITH MAGNETIC ELEMENT

(71) Applicants: Reutter GmbH, Leutenbach (DE); Bakker Holding Son B.V., Son (NL)

(72) Inventors: Nicola Fiore, Leutenbach (DE); Igor Al, Schwaikheim (DE); Sergio Zaccagni, Welzheim (DE); Frank Horlacher, Korb (DE); Maximilian Kraus, Weinstadt (DE); Niels Johannes Kersten, Volkel (NL); IJsbrand Velzeboer, Eindhoven (NL)

(73) Assignees: Reutter GmbH, Leutenbach (DE); Bakker Holding Son B.V., Son (NL)

(21) Appl. No.: 15/904,887

(22) Filed: Feb. 26, 2018

(30) Foreign Application Priority Data
Feb. 24, 2017 (DE) 10 2017 103 846.9

(51) Int. Cl. B60K 15/04; F01N 3/28

(52) U.S. Cl. CPC B60K 15/04; B60Y 2410/132; B60K 2015/0458; F01N 3/2896

(57) ABSTRACT

Filler neck, including a passage extending along a longitudinal axis, at least one permanently magnetic element being arranged annularly around the longitudinal axis, at least in regions, outside the passage and able to generate a permanent magnetic field in the passage, and either at least one ferromagnetic element arranged annularly around the longitudinal axis, at least in regions, outside the passage, the at least one permanently magnetic element and the at least one ferromagnetic element being arranged so as to be adjacent and so as to overlap, at least in regions, viewed in the direction of the longitudinal axis, or the at least one permanently magnetic element having a height, viewed in the direction of the longitudinal axis, that is different from 10 mm, and arranged in the filler neck such that a magnetic field generated by the at least one permanently magnetic element has a maximum attractive force, towards the longitudinal axis, in a specified position in the passage.

### CROSS-REFERENCE TO RELATED APPLICATIONS

This application claims priority to German patent application No. 102017103846.9, filed on Feb. 24, 2017, the entire disclosure of which is incorporated herein by reference.

### BACKGROUND OF THE INVENTION

1. The invention relates to a filler neck comprising a magnetic element.

Filler necks of this kind, and corresponding pump nozzles, form a system for filling a tank with aqueous urea solution, AUS 32, for a system for reducing nitrogen oxide, NOₓ, by means of selective catalytic reduction, SCR. The filler neck comprises a magnetic ring that is manufactured from neodymium iron boron (NdFeB). This alloy is particularly suitable for producing very strong permanent magnets. However, the costs of magnets of this kind make up a significant portion of the costs of filler necks. Weight reduction, functional optimization and sparing use of rare earth metals are also desirable.

A filler neck comprising a magnetic ring that is improved in relation thereto is therefore desirable.

### SUMMARY OF THE INVENTION

In one aspect this is achieved by a filler neck characterized by a passage extending along a longitudinal axis, at least one permanently magnetic element arranged annularly around the longitudinal axis, at least in regions, outside the passage, wherein the at least one permanently magnetic element is able to generate a permanent magnetic field in the passage; at least one ferromagnetic element arranged annularly around the longitudinal axis, at least in regions, outside the passage, wherein the at least one permanently magnetic element and the at least one ferromagnetic element are arranged so as to be adjacent and so as to overlap, at least in regions, viewed in the direction of the longitudinal axis.

### BRIEF DESCRIPTION OF THE DRAWINGS

The invention will be explained in greater detail in the following, with reference to an embodiment. In the drawings:

FIG. 1 is a schematic longitudinal section through a filler neck and a spout of a pump nozzle,

FIG. 2 is a schematic first longitudinal section through a filling head portion and a spout,

FIG. 3 schematically shows a first embodiment of a magnetic ring,

FIG. 4 schematically shows a second embodiment of the magnetic ring,

FIG. 5 shows an attractive force curve.

### DETAILED DESCRIPTION

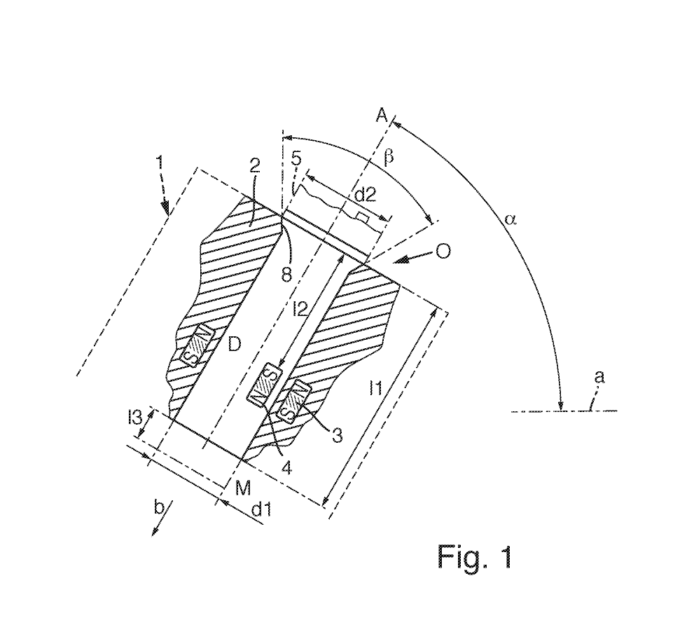

FIG. 1 is a schematic longitudinal section through a filler neck 1. The filler neck 1 is preferably symmetrical with respect to an axis A. The filler neck 1 extends along the axis A in the longitudinal direction. The axis A is preferably inclined relative to a horizontal a by an angle α when the filler neck is in an installation position.

The filler neck comprises a filling head portion 2. The filling head portion 2 preferably extends symmetrically along the longitudinal axis A. The filling head portion 2 comprises a passage D having a preferably substantially circular first inner cross section. The first inner cross section preferably has a first inner diameter d1. The filling head portion 2 preferably extends from an open end O of the filling head 1 by a first length 11 along the longitudinal axis. The filling head portion 2 has a step 8 at the open end O, as a result of which step the passage D tapers from the open end O to the first inner cross section. The filling head portion 2 has a preferably substantially circular second inner cross section at the open end. The second inner cross section preferably has a second inner diameter d2 that is larger than the first inner diameter d1. The step 8 preferably causes the inner cross section to taper at an angle β

A magnetic ring 3 is arranged in the filling head portion. The magnetic ring 3 is preferably arranged so as to be perpendicular to the longitudinal axis A and surrounds the passage D. A spacing between an end face of the magnetic ring 3 that faces the open end O and the open end O has a second length 12.

A mouth M of a spout 5 of a pump nozzle is equipped with a steel ball or another element made of a magnetic or ferromagnetic material, or with a solenoid switch 4. The solenoid switch 4 will be explained in the following as an example. The function is the same using a ferromagnetic switch, the steel ball or other elements. The solenoid switch 4 is designed to usually close a return pipe of the spout 5 in the valve when in a home position. The return pipe, the valve and the solenoid switch 4 are part of a sensor system of the pump nozzle, which system is intended to prevent fluid urea unintentionally leaking out of the mouth M. The filler neck 1 is designed to receive the spout 5. In this case, the spout 5 penetrates the passage D in the longitudinal direction, from the open end O, preferably to a maximum depth at which the mouth M protrudes beyond the filling head portion 2 by a third length 13 on the side remote from the open end O. In the process, the pump nozzle reaches an end stop that is formed by the step 8 for example. Said stop marks an end position of the spout 5 in the filler neck 1 and in the filling head portion 2. The spout 5 preferably had an outer periphery that corresponds to the inner periphery of the step 8. In this case, the step 8 is the mechanical stop that limits the penetration of the spout 5 into the filler neck 1.

The magnetic ring 3 is thus arranged on or in the filler neck 1 in such a way as to interact with the solenoid switch 4 when the spout 5 is inserted into the filler neck 1, in order to open the return pipe in the spout 5, by means of the valve, when the spout 5 reaches the end position in the filler neck 1.

The solenoid switch 4 interacts with the magnetic ring 3 in such a way that, irrespective of the valve type and the arrangement, the valve closes reliably in the normal state and opens reliably only when the magnetic ring 3 and the solenoid switch 4 are arranged in the end position, i.e. at a specified position relative to one another. Instead of a solenoid switch 4, equivalent devices can also be used, which devices can be actuated by the magnetic ring 3 in the same way as the solenoid switch 4.

In the following figures, components having the same or similar functions are denoted by the same reference signs.

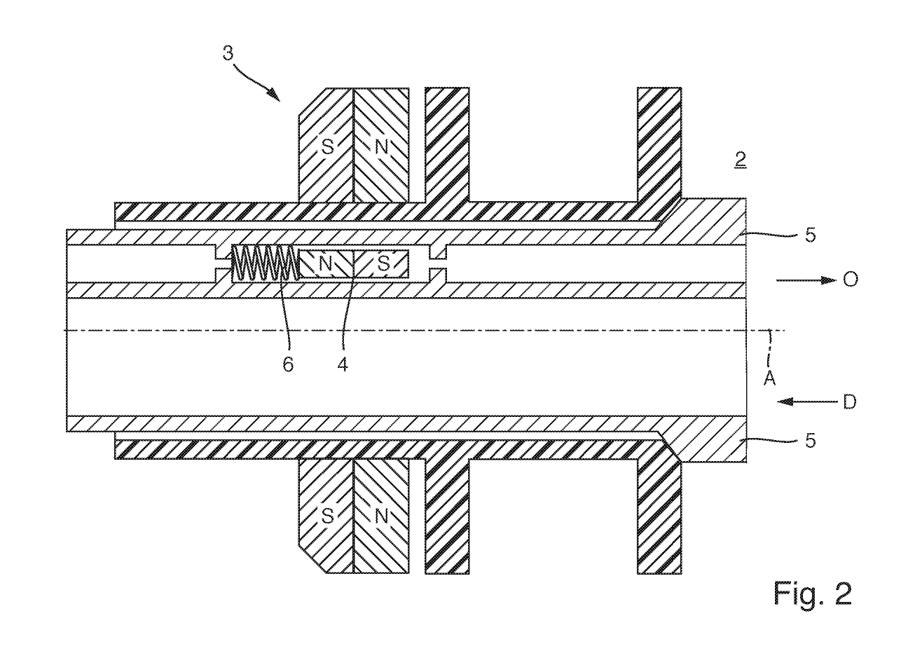

FIG. 2 is a schematic longitudinal section through a filling head portion 2 of this kind and a spout 5 of this kind, in which a valve is inserted so as to be arranged in parallel with the longitudinal axis A. In this case, both the valve arrangement and the valve type are such that the magnetic ring 3 reliably opens the valve only when close to or in the end position. In all other positions, the valve closes reliably. The valve comprises the solenoid switch 4. The solenoid switch 4 comprises a permanent magnet which is designed as a bar magnet for example and the south pole of which is arranged on a side of the solenoid switch 4 facing the open end O when the spout 5 is inserted into the filling head portion 2. A valve of another type may comprise a steel ball. Instead of a bar magnet, the magnet may be of any desired shape, for example the magnet may be rod-shaped, spherical, annular or block-shaped element. The ball or another member made of a magnetic or ferromagnetic material can also be used for example.

Irrespective of the valve type, in the normal state the valve is held in a closed position for example by means of a pressure spring 6 that acts on the solenoid switch 4 as a closure part of the valve. In order to open the valve, the spring force counteracts a magnetic force generated by the magnetic field of the magnetic ring 3. The solenoid switch 4 has to be designed such that the valve opens reliably in the magnetic field of the magnetic ring 3. This also defines minimum requirements for the magnetic ring 3. The magnetic ring 3 and the solenoid switch 4 are preferably arranged such that, during the filling process, an equilibrium of forces is established or an opening force component predominates. For this purpose, a north pole of the magnetic ring 3 is arranged in the filling head portion 2 on the side of the magnetic ring 3 facing the open end O. A south pole is arranged on the side of the magnetic 3 remote from the open end O. The magnetic ring 3 and the bar magnet are therefore arranged having a mutually opposed polarization in the example.

Embodiments of the magnetic ring 3 will be described in the following examples.

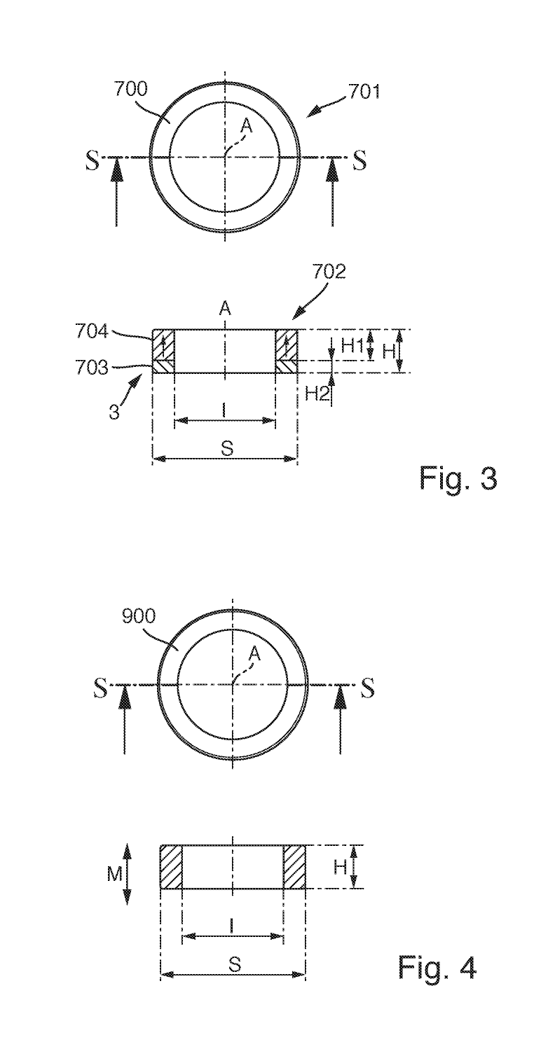

FIG. 3 is a plan view 701 and a cross section 702 of a first embodiment of a magnetic ring 700.

The magnetic ring 700 is preferably annular, having an inner diameter I and an outer diameter A. The inner diameter I and outer diameter A are selected such that the magnetic ring 700 can be inserted in the SCR filler neck.

The magnetic ring 700 has a height H. The magnetic ring 700 preferably comprises ferromagnetic material 703 and magnetic material 704. A south pole of the magnetic material 704 is arranged on a side of the magnetic material 704 facing the ferromagnetic material 703. A north pole of the magnetic material 704 is arranged on a side of the magnetic material 704 remote from the ferromagnetic material 703. The height H is composed of a first height H1 of the magnetic material 704 and a second height H2 of the ferromagnetic material 703.

The magnetic ring 700 is arranged in the filling head port 2 as described above, in accordance with said magnetic polarity. As a result of this combination and arrangement, the magnetic field is concentrated in the region of the solenoid switch 4. As a result, the magnetic field required for reliably opening and keeping open the valve in the end position is generated without the need for the entire height H to be filled with magnetic material.

The overall dimensions of the magnetic ring 700 are such that the magnetic ring 700 can be inserted in the region of the filling head portion 2 provided for the magnetic ring 3. Optionally, a spacer that is not permanently magnetic and is not ferromagnetic may be provided in order to fill a spacing that may remain between the magnetic ring 700 and the filling head portion.

In the case of different second heights H2 of the ferromagnetic material 703 but a constant height H, the first height H1 of the magnetic material 704 varies: H1=H−H2. The less magnetic material 704 that is used, the more cost-effectively the magnetic ring 700 can be produced. However, the requirements for reliable opening must continue to be complied with in every case for the described valve and the described arrangements.

In general, any other embodiment of a bimetal arrangement of this kind can be used. Other permanently magnetic materials can also be used.

As an alternative to the magnetic ring 700, an arrangement without ferromagnetic material can also be used instead of the bimetal arrangement. This will be described in the following.

FIG. 4 shows a second embodiment of a magnetic ring 900. The magnetic ring 900 is preferably annular, as has been described for the magnetic ring 700. A height H of the magnetic ring 900 corresponds to the height of the magnetic material 901. The height H is different from 10 mm.

The magnetic ring 900 is arranged in the filling head portion 2 as has been described above for the magnetic ring 3. Accordingly, the same magnetic polarity results as that described for the magnetic ring 3.

The height H of the magnetic material, and thus of the magnetic ring 900, is different from 10 mm. The magnetic ring 900 is arranged such that, when the spout 5 is in the end position in the filling head portion 2, the magnetic field is maximized in a region in which the solenoid switch 4 is located.

As a result of this combination and arrangement, the magnetic field is concentrated in the region of the solenoid switch 4. As a result, the magnetic field required for reliably opening and keeping open the valve in the end position is generated using a magnet having a smaller height.

The overall dimensions of the magnetic ring 900 are such that the magnetic ring 900 can be inserted in an SCR filler neck. The magnetic ring 900 is arranged such that the maximum magnetic field strength, i.e. the maximum attractive force is reached, when the solenoid switch 4 holds the valve completely open in the end position. For this purpose, the north pole and south pole contact surfaces of the permanent magnets are not arranged in the same plane when the solenoid switch 4 is used. The magnetic ring 900 is arranged in the filler neck 1 such that a magnetic field generated by the magnetic ring 900 develops a maximum attractive force in the direction of the longitudinal axis A in the specified end position of the solenoid switch 4.

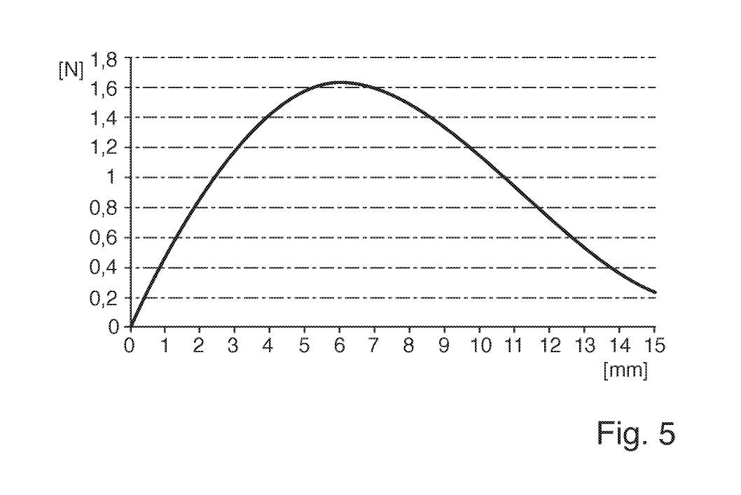

FIG. 5 shows a curve of an attractive force that acts on the closure part of the valve in a first arrangement according to FIG. 3. The curve ends, at the right-hand edge of FIG. 5, in a zero position in which the north pole and south pole contact surfaces of the permanent magnets are arranged in the same plane, as shown in FIG. 1 or FIG. 2.

The curve shown is one for a height H of the magnetic material. Magnetic material of a different thickness has a comparable curve, depending on the height that is considered. The less magnetic material that is used, the more cost-effectively a magnetic ring can be produced. However, the requirements for reliable opening must continue to be complied with in every case for the described valve and the described arrangements. Said requirements result from an attractive force, as shown in FIG. 5. A spacing in millimeters, mm, is shown on the x-axis and a force in newtons, N, is shown on the y-axis. In this example, the curve of the attractive force begins at 0 mm and 0 N and increases up to a maximum value of 1.64 N at 6 mm. Thereafter, the attractive force drops to 0.23 N at 15 mm.

The magnetic rings 700, 900 are arranged at a first distance, viewed in the direction of the longitudinal axis A, viewed from the open end O of the filler neck 1. The first distance is dependent on the height H and/or the thickness of the magnetic material and is specified such that, in the end position in which the spout 5 is located in the passage D, the maximum attractive force in the direction of the longitudinal axis A develops at a second distance from the open end O of the filler neck 1, viewed in the direction of the longitudinal axis A.

Magnetic rings 700, 900 are preferably manufactured from a plurality of annulus sector elements that are directly adjacent to one another. It is also possible to use annulus sector elements that are mutually spaced. The annulus made of the ferromagnetic material of the magnetic ring 700 can be integral. Steel, for example, is used as the ferromagnetic material.

The spacer may also be a part of the magnetic ring. Instead of the spacer, an air gap may also be provided. The magnetic ring is then fixed for example along the inner face, outer face or along the other end face thereof in the filling head portion 2.

The magnetic ring 900 is preferably designed such that the magnetic field M emerges along the longitudinal axis A in parallel with the longitudinal direction, i.e. at an angle of emergence of 0°.

It is particularly preferable for the magnetic ring 900 to be formed such that the magnetic field M emerges at a different angle of emergence, i.e. not in parallel with the longitudinal direction. The magnetic field M preferably emerges at an angle of emergence of between 0° and 45° for example. As a result, the position of the magnetic field maximum can be influenced particularly easily. For example, for this purpose, bar magnet-like elements that are tilted by the angle of emergence, relative to the longitudinal axis A, at least in portions, are arranged so as to be annularly adjacent to one another. In addition, as described for the magnetic ring 700, a steel ring, as the ferromagnetic material 703, can support the bar magnet-like elements. Steel segments can be used instead of the steel ring. Another ferromagnetic material can be used instead of steel.

What is claimed is:

1. Filler neck, comprising:
a passage extending along a longitudinal axis (A),
at least one permanently magnetic element arranged annularly around the longitudinal axis, at least in regions, outside the passage, and being able to generate a permanent magnetic field in the passage,
at least one ferromagnetic element arranged annularly around the longitudinal axis, at least in regions, outside the passage,
the at least one permanently magnetic element and the at least one ferromagnetic element being arranged so as to be adjacent and so as to overlap, at least in regions, viewed in the direction of the longitudinal axis.

2. Filler neck according to claim 1, characterized in that at last one of the one annular ferromagnetic element (703) supports the at least one permanently magnetic element, and in that a plurality of annularly arranged ferromagnetic elements that are directly adjacent to one another or mutually spaced support the at least one permanently magnetic element.

3. Filler neck, comprising:
a passage extending along a longitudinal axis,
at least one permanently magnetic element being arranged annularly around the longitudinal axis, at least in regions, outside the passage, the at least one permanently magnetic element being able to generate a permanent magnetic field in the passage,
the at least one permanently magnetic element having a height, viewed in the direction of the longitudinal axis, that is different from 10 mm,
the at least one permanently magnetic element being arranged in the filler neck such that a magnetic field generated by the at least one permanently magnetic element has a maximum attractive force, towards the longitudinal axis, in a specified position in the passage.

4. Filler neck according to claim 3, characterized in that the at least one permanently magnetic element is arranged at a first distance, viewed in the direction of the longitudinal axis, viewed from an open end of the filler neck, which first distance differs from a second distance of the specified position in the passage.

5. Filler neck according to claim 3, characterized in that a plurality of permanently magnetic elements are arranged either directly adjacently to one another, as one annular element, or so as to be mutually spaced, as a plurality of annulus sector elements.

6. Filler neck according to claim 3, characterized in that the direction of magnetization of the permanently magnetic element extends in parallel with the longitudinal axis.

7. Filler neck according to claim 3, characterized in that the direction of magnetization of the permanently magnetic element extends so as to not be in parallel with the longitudinal axis.

8. Filler neck according to claim 1, characterized in that a plurality of permanently magnetic elements are arranged either directly adjacently to one another, as one annular element, or so as to be mutually spaced, as a plurality of annulus sector elements.

9. Filler neck according to claim 1, characterized in that the direction of magnetization of the permanently magnetic element extends in parallel with the longitudinal axis.

10. Filler neck according to claim 1, characterized in that the direction of magnetization of the permanently magnetic element extends so as to not be in parallel with the longitudinal axis.
